(19) United States
(12) Patent Application Publication
(10) Pub. No.: US 2005/0177724 A1
(43) Pub. Date: Aug. 11, 2005

(54) Authentication system and method

(76) Inventors: Valiuddin Ali, Houston, TX (US); Manuel Novoa, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/036,288

(22) Filed: Jan. 14, 2005

Related U.S. Application Data
(60) Provisional application No. 60/537,187, filed on Jan. 16, 2004.

(51) Int. Cl. H04L 9/00

(52) U.S. Cl. 713/168

(57) ABSTRACT

An authentication system comprises an authentication enforcement engine adapted to interface with an authentication provider for performing an authentication process for a user requesting access to a computer resource. The system also comprises a dynamic enforcer engine adapted to interface with the authentication enforcement engine to determine applicability of a dynamic authentication policy for the authentication process.

### BACKGROUND OF THE INVENTION

Multifactor authentication policies generally specify a combination of authentication factors for verifying a user's identity. For example, such authentication factors generally comprise a combination of two or more of a password, smart card, biometric, or other type of identifier to authenticate the identity of a user requesting to access a particular computer service and/or environment. However, with the variety of types of environments and/or systems from which access to a resource may be requested (e.g., wireless and/or remote access, different types of hardware and/or software, etc.), additional security measures are generally needed to safeguard valuable information.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of an authentication system in accordance with the present invention; and

FIG. 2 is a flow chart illustrating an embodiment of an authentication method in accordance with the present invention.

### DETAILED DESCRIPTION OF THE DRAWINGS

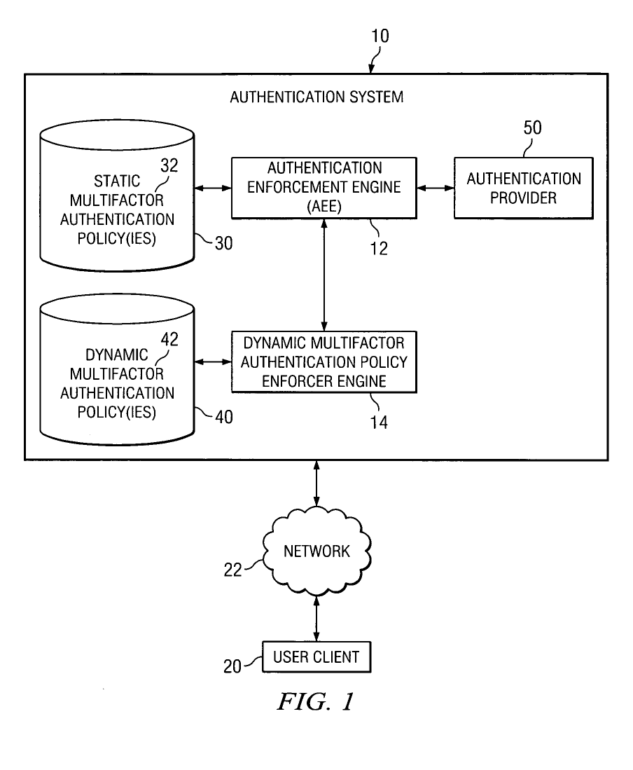

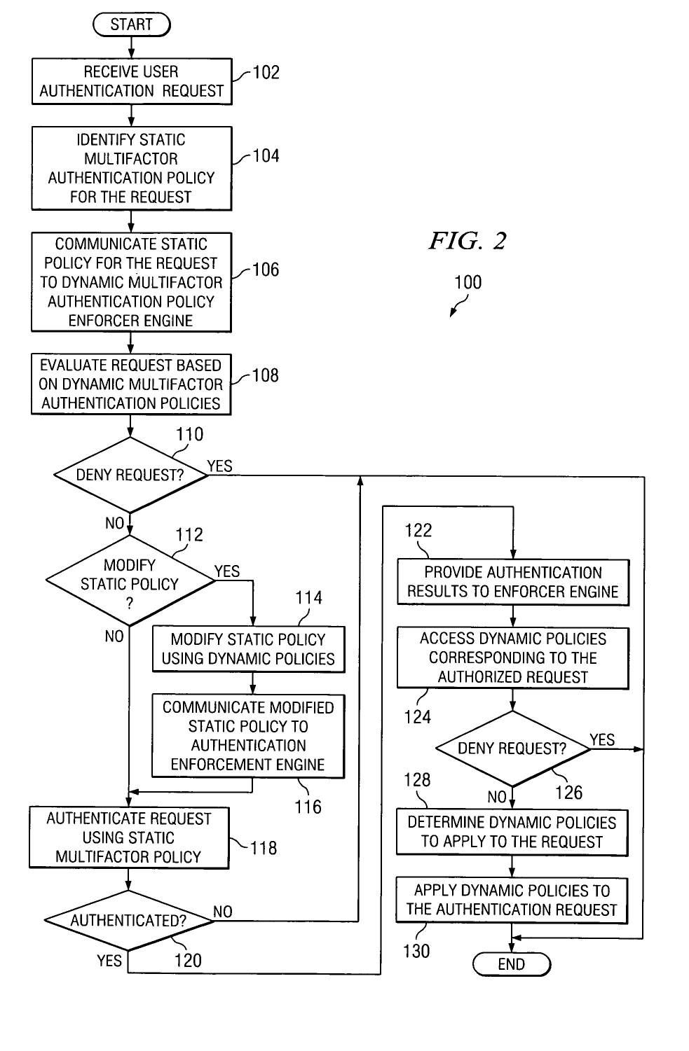

The preferred embodiments of the present invention and the advantages thereof are best understood by referring to FIGS. 1 and 2 of the drawings, like numerals being used for like and corresponding parts of the various drawings.

FIG. 1 is a diagram illustrating an embodiment of an authentication system 10 in accordance with the present invention. In the embodiment illustrated in FIG. 1, authentication system 10 comprises an authentication enforcement engine (AEE) 12 and a dynamic multifactor authentication policy enforcer engine 14. AEE 12 and enforcer engine 14 may comprise software, hardware, or a combination of software and hardware. In operation, AEE 12 and enforcer engine 14 cooperate to dynamically determine authentication factors for authenticating an identity of a user and/or dynamically determine access rights and/or limitations for accessing and/or otherwise using various types of computer services and/or resources. For example, in the embodiment illustrated in FIG. 1, a user client 20 is communicatively coupled to authentication system 10 via a communication network 22. Communication network 22 may comprise a wired and/or wireless network for communicatively interfacing user client 20 with authentication system 10. In the embodiment illustrated in FIG. 1, AEE 12 and enforcer engine 14 are illustrated as separate components. However, it should be understood that the operations and/or functions performed by AEE 12 and enforcer engine 14 may be performed by a single component (e.g., a single software application and/or hardware component).

User client 20 may comprise any type of devices for accessing and/or otherwise using a computer resource such as, but not limited to, a notebook or laptop computer, server-based system, personal digital assistant, telephone or a desktop computer or workstation. The protected and/or secure computer resource may comprise a wide area network (WAN), local area network (LAN), a particular memory and/or data storage component or module, a particular software application, a server or any other type of computer resource of which secure access and/or user authentication is desired. In the embodiment illustrated in FIG. 1, user client 20 accesses and/or otherwise interfaces with authentication system 10 via communication network 22. Thus, for example, authentication system 10 may reside on a server or other type of centralized computer network resource such that user client 20 is remotely located relative to authentication system 10. However, additionally, or alternatively, authentication system 10 may be disposed on and/or otherwise forms a part of user client 20.

In the embodiment illustrated in FIG. 1, authentication system 10 comprises at least one storage or memory element 30 having at least one static multifactor authentication policy (SMAP) 32 identifying at least one authentication factor, rule, guideline and/or an authentication method or procedure for authenticating the identity of a user desiring to access and/or otherwise utilize a secure computer resource. Such authentication factor, rule, guideline, method and/or procedure may comprise and/or otherwise indicate a combination of two or more identification methods and/or devices such as, but not limited to, a password, a smart card or a biometric (e.g., a fingerprint, voice, face and/or iris/retinal scan). The static multifactor authentication policy 32 may be based on information initially received from the user (e.g., a username or other type of initial identifier), the type of request (e.g., access to a particular computer resource), or another factor.

In the embodiment illustrated in FIG. 1, authentication system 10 comprises at least one storage or memory element 40 having at least one dynamic multifactor authentication policy 42 for dynamically modifying a static policy 32 for authenticating an identity of a user and/or otherwise restricting and/or limiting access to particular computer resources based on factors such as, but not limited to, the condition of the user client 20 (e.g., how the user client 20 would be accessing the resource (e.g., wired or wirelessly), the environment from which user client 20 would be accessing the resource (e.g., remotely or from within a controlled environment), the type of the user client 20 that would be used to access the resource (e.g., one capable of only viewing secure information versus one capable of storing, copying and/or transferring such information), the time of day access is requested, the capabilities of the user client 20 that would be used to access the resource (e.g., one capable of decrypting sensitive information)) and/or any combination thereof. Thus, embodiments of the present invention automatically (e.g., without further intervention by a user or another) and dynamically (e.g., responsive to conditions associated with the request and/or user client at the time, instance and/or session of the request and/or in response to a change in conditions associated with the request or session (e.g., in response to a request to access another resource and/or additional resources)) authenticate an identity of a user and/or otherwise restrict and/or limit access to particular computer resources.

In the embodiment illustrated in FIG. 1, authentication system 10 also comprises an authentication provider 50 which may comprise hardware, software, or a combination of hardware and software. Authentication provider 50 is used by authentication enforcement engine 12 to authenticate the identity of a user based on a particular static policy 32. For example, authentication provider 50 may comprise an application or resource for authenticating a password provided by a user, a fingerprint or other type of biometric provided by the user, smart card verification, or another type of application or module for authenticating and/or otherwise verifying a particular authentication factor.

In operation, in accordance with one embodiment of the present invention, authentication enforcement engine 12 receives a request from a user desiring to access and/or otherwise use a particular computer resource. In response to receiving the request, authentication enforcement engine 12 accesses and/or otherwise retrieves a static multifactor authentication policy 32 for the request. In response to receiving and/or otherwise determining the static authentication policy 32, authentication enforcement engine 12 interfaces with enforcer engine 14 and communicates a copy and/or instance of the static authentication policy 32 to enforcer engine 14 (e.g., such that the SMAP 32 stored and/or otherwise identified in element 30 remains unchanged). Enforcer engine 14 accesses and/or otherwise retrieves a dynamic multifactor authentication policy 42 for the request to determine whether a modification to the static authentication policy 32 should be made for the request. In some embodiments of the present invention, the determination whether to modify the static authentication policy 32 for the request is based on how the user client 20 would be accessing the resource (e.g., wired or wirelessly), the environment from which user client 20 would be accessing the resource (e.g., remotely or from within a controlled environment), or the type of user client 20 that would be used to access the resource (e.g., one capable of only viewing secure information versus one capable of storing, copying and/or transferring such information). For example, the static authentication policy 32 for the request may indicate that a password and smart card are used for authenticating the user. However, based on the environment and/or connection mode from which the user is desiring access to the particular computer resource (e.g., wirelessly and/or remote), the dynamic authentication policy 42 may indicate denial of the request or may indicate an additional form of authentication such as, but not limited to, a biometric to be acquired from the user. Information used by enforcer engine 14 to evaluate the static authentication policy 32 using dynamic authentication policy 42 may be acquired using a variety of methods and/or techniques such as, but not limited to, information provided by and/or requested from the user and/or information acquired transparently from and/or associated with the user (e.g., an Internet protocol address or other means to identify a user's location).

Authentication enforcement engine 12 authenticates the identity of the user using the static authentication policy 32 either in an original form or as modified by enforcer engine 14. For example, in some embodiments of the present invention, authentication enforcement engine 12 interfaces with authentication provider 50 to verify the information provided by and/or otherwise received from the user. In some embodiments of the invention, authentication enforcement engine 12 forwards and/or otherwise communicates the results of the authentication process received by authentication provider 50 (e.g., identity authenticated) to enforcer engine 14. In response to receiving the results of the authentication process from authentication enforcement engine 12, enforcer engine 14 accesses, retrieves and/or otherwise identifies a dynamic authentication policy 42 for the request to determine whether additional access limitations and/or authentication factors should be implemented and/or requested, thereby modifying and/or otherwise dynamically responding to the authentication result (e.g., dynamically determining access rights to the computer resource such as an authorization level and/or access to particular types of information). For example, if the user is attempting to access a computer resource via a wireless link and/or a remote location, dynamic authentication policy 42 may indicate a denial of access to particular resources while enabling access to other resources and/or request additional authentication factors for particular resources (e.g., a biometric requested from the user for accessing particular resources), thereby establishing, identifying, enforcing and/or otherwise implementing a particular authorization level for the request and/or user. Thus, for example, although the user may be granted access to particular computer network resources, access to particular resources may be restricted and/or otherwise limited based on the dynamic policy 42. Further, in some embodiments of the present invention, enforcer engine 14 is adapted to interface with user client 20 to implement the particular dynamic policy 42 such as, but not limited to, disabling a decryption device on such user client 20, thereby preventing decryption of sensitive information by the user client 20 and/or verifying and/or otherwise ensuring that a particular type of cryptographic device is present on user client 20 for accessing particular resources. Preferably, in at least one embodiment of the present invention, dynamic authentication of an identity of the user and/or secure computer resource access restrictions/limitations are determined and/or implemented in real time (e.g., immediately and/or without noticeable or appreciable delay).

FIG. 2 is a flow diagram illustrating an embodiment of an authentication method 100 in accordance with the present invention. The method begins at block 102, where authentication enforcement engine 12 receives an authentication request from a user. At block 104, authentication enforcement engine 12 accesses and/or otherwise retrieves and identifies a static multifactor authentication policy 32 corresponding to the user and/or request. At block 106, authentication enforcement engine 12 communicates a copy or instance of the identified static multifactor authentication policy 32 to enforcer engine 14.

At block 108, enforcer engine 14 accesses, retrieves and/or otherwise identifies a dynamic multifactor authentication policy 42 corresponding to the user and/or request and evaluates the request based on the dynamic multifactor authentication policy 42. At decisional block 110, a determination is made by enforcer engine 14 whether to grant or deny the request. For example, in some embodiments of the present invention, based on the environment and/or communication medium from or by which the user is attempting to access a secure computer resource (e.g., wirelessly and/or remote), dynamic multifactor authentication policy 42 may indicate a denial of the request regardless of the identity of the user and/or available authentication factors. If the request is denied, the method ends. If the request is granted, the method proceeds from decisional block 110 to decisional block 112, where enforcer engine 14 determines whether the dynamic multifactor authentication policy 42 indicates that the instance static multifactor authentication policy 32 should be modified for the request. If the dynamic multifactor authentication policy 42 indicates that the static multifactor authentication policy 32 should be modified for the particular request, the method proceeds to block 114, where enforcer engine 14 modifies the static multifactor authentication policy 32 for the particular request based on the dynamic policy 42. At block 116, enforcer engine 14 communicates the modified the static authentication policy 32 to authentication enforcement engine 12. At decisional block 112, if the dynamic authentication policy 42 does not indicate that the static authentication policy 32 should be changed for the particular request, the method proceeds from decisional block 112 to block 118. At block 118, authentication enforcement engine 12 authenticates the request (e.g., via authentication provider 50) using the static authentication policy 32 (in its original form or as modified by enforcer engine 14).

At decisional step 120, a determination is made whether the identity of the request and/or user has been authenticated using the current static authentication policy 32 (e.g., in its original form or as modified by enforcer engine 14). If the request and/or user has not been authenticated, the method ends. If the user and/or request has been authenticated, the method proceeds to block 122, where the result of the authentication process is communicated and/or otherwise provided to enforcer engine 14 by authentication enforcement engine 12. At block 124, enforcer engine 14 accesses, retrieves and/or otherwise identifies a dynamic authentication policy 42 corresponding to the user and/or request. At decisional step 126, enforcer engine 14 determines whether the request should be denied based on the dynamic authentication policy 42. If the enforcer engine 14 determines that the request should be denied, the method ends. If the enforcer engine 14 determines that the request should be granted, the method proceeds to block 128, where enforcer engine 14 determines whether additional restrictions and/or limitations should be placed on the request and/or access based on the dynamic authentication policy 42. If additional restrictions and/or limitations should be placed on the request and/or access, enforcer engine 14 applies the dynamic authentication policy 42 to the authentication request.

Thus, embodiments of the present invention provide a dynamically responsive authentication system and method. For example, based on the mode of a network connection (e.g., wired or wireless, local or remote, etc.) or other environmental factors associated with the request, the authentication request may be denied, additional and/or different authentication factors utilized, and/or particular limitations and/or restrictions imposed. In the embodiments illustrated in FIGS. 1 and 2, dynamic policies 42 associated with access restrictions and/or limitations to various computer resources are evaluated after user/request authentication (e.g., after evaluation and implementation, if indicated, of a modified static policy 32 for authenticating the user/request). However, it should be understood that dynamic policies 42 for a particular request (e.g., modification to a static policy 32 and/or access limitations/restrictions) may be performed concurrently for a particular request. It should also be understood that in other embodiments of the method of the present invention described in FIG. 2, certain functions may be omitted, combined, or accomplished in a sequence different than depicted in FIG. 2. Also, it should be understood that the method depicted in FIG. 2 may be altered to encompass any of the other features or aspects described elsewhere in the specification.

1. An authentication system, comprising:
an authentication enforcement engine adapted to interface with an authentication provider for performing an authentication process for a user requesting access to a computer resource; and
a dynamic enforcer engine adapted to interface with the authentication enforcement engine to determine applicability of a dynamic authentication policy for the authentication process.

2. The system of claim 1, wherein the dynamic enforcer engine is adapted to dynamically modify a static authentication policy based on the dynamic authentication policy.

3. The system of claim 1, wherein the dynamic enforcer engine is adapted to receive a static authentication policy from the authentication enforcement engine.

4. The system of claim 1, wherein the dynamic enforcer engine is adapted to dynamically determine an authorization level for the user based on the dynamic authentication policy.

5. The system of claim 1, wherein the dynamic enforcer engine is adapted to determine the applicability of a dynamic authentication policy for the authentication process in real time.

6. The system of claim 1, wherein the dynamic enforcer engine is adapted to communicate a modified static authentication policy based on the dynamic authentication policy to the authentication enforcement engine.

7. The system of claim 1, wherein the authentication enforcement engine is adapted to apply a modified static authentication policy received from the dynamic enforcer engine in the user authentication process.

8. The system of claim 1, wherein the dynamic enforcer engine is adapted to determine a condition of a user client for determining applicability of the dynamic authentication policy in the user authentication process.

9. The system of claim 8, wherein the dynamic enforcer engine is adapted to determine whether the condition indicates the request was wirelessly communicated.

10. A user authentication method, comprising:
interfacing with an authentication provider for performing an authentication process for a user requesting access to a computer resource using at least one static authentication policy; and
interfacing with a dynamic enforcer engine to determine applicability of a dynamic authentication policy for the authentication process.

11. The method of claim 10, further comprising dynamically modifying the static authentication policy based on the dynamic authentication policy.

12. The method of claim 10, further comprising dynamically determining an authorization level for the user based on the dynamic authentication policy.

13. The method of claim 10, wherein interfacing comprises determining the applicability of a dynamic authentication policy for the authentication process in real time.

14. The method of claim 10, further comprising applying a modified static authentication policy received from the dynamic enforcer engine in the user authentication process.

15. The method of claim 10, further comprising determining a condition of a user client for determining applicability of the dynamic authentication policy in the user authentication process.

16. The method of claim 15, wherein determining the condition of the user client comprises determining whether the condition indicates a wireless communication with the user client.

17. The method of claim 15, wherein determining the condition of the user client comprises determining whether the condition indicates a remote user client.

18. The method of claim 10, further comprising communicating the static authentication policy corresponding to the user for use during the user authentication process to the dynamic enforcer engine.

19. An authentication system, comprising:
means for interfacing with an authentication provider for performing an authentication process for a user requesting access to a computer resource using at least one static authentication policy; and
means for determining applicability of a dynamic authentication policy for the authentication process.

20. The system of claim 19, further comprising means for dynamically modifying the static authentication policy for the authentication process.

21. The system of claim 19, further comprising means for dynamically determining a condition of a user client for the authentication process.

22. The system of claim 19, further comprising means for implementing the dynamic authentication policy based on a condition of a user client requesting the authorization process.

23. An authentication system, comprising:
an authentication enforcement engine adapted to authenticate a user requesting access to a computer resource; and
a dynamic enforcer engine adapted to interface with the authentication enforcement engine to determine applicability of a dynamic policy for determining an access right associated with the computer resource.

24. The system of claim 23, wherein the dynamic enforcer engine is adapted to determine a condition of a user client for determining applicability of the dynamic policy.

25. The system of claim 24, wherein the dynamic enforcer engine is adapted to determine whether the condition indicates the request was wirelessly communicated.

26. The system of claim 23, wherein the dynamic enforcer engine is adapted to determine an environment from which the user is requesting access to the computer resource.

27. The system of claim 23, wherein the dynamic enforcer engine is adapted to disable a decryption capability of a user client from which the user is requesting access to the computer resource.

28. The system of claim 23, wherein the dynamic enforcer engine is adapted to dynamically identify a particular authentication factor to be requested from the user for accessing a particular computer resource.

29. An authentication system, comprising:
an authentication enforcement engine adapted to receive a request from a user to access a computer resource; and
a dynamic enforcer engine adapted to interface with the authentication enforcement engine to determine applicability of a dynamic policy for the request.

30. The system of claim 29, wherein the dynamic enforcer engine is adapted to determine a condition of a user client for determining applicability of the dynamic policy.

31. The system of claim 30, wherein the dynamic enforcer engine is adapted to determine whether the condition indicates the request was wirelessly communicated.

32. The system of claim 29, wherein the dynamic enforcer engine is adapted to determine an environment from which the user is requesting access to the computer resource.

33. The system of claim 29, wherein the dynamic enforcer engine is adapted to disable a decryption capability of a user client from which the user is requesting access to the computer resource.

34. The system of claim 29, wherein the dynamic enforcer engine is adapted to dynamically identify a particular authentication factor to be received from the user for accessing a particular computer resource.
